(19) United States
(12) Patent Application Publication
(10) Pub. No.: US 2003/0097439 A1
(43) Pub. Date: May 22, 2003

(54) Systems and methods for identifying anomalies in network data streams

(76) Inventors: William Timothy Strayer, West Newton, MA (US); Craig Partridge, Lansing, MI (US); James K. Weixel, Ashland, MA (US)

Correspondence Address: VERIZON CORPORATE SERVICES GROUP INC., C/O CHRISTIAN R. ANDERSON, 600 HIDDEN RIDGE DRIVE, MAILCODE HQEO3HO1, IRVING, TX, 75038, US

(21) Appl. No.: 10/289,247

(22) Filed: Nov. 6, 2002

Related U.S. Application Data
(63) Continuation-in-part of application No. 10/167,620, filed on Oct. 19, 2001.
(60) Provisional application No. 60/355,573, filed on Feb. 5, 2002.
(60) Provisional application No. 60/242,598, filed on Oct. 23, 2000.

(51) Int. Cl. G06F 15/173

(52) U.S. Cl. 709/224

(57) ABSTRACT

A traffic auditor (130) analyzes traffic in a communications network (100). The traffic auditor (130) performs traffic analysis on traffic in the communications network (100) and develops a model of expected traffic behavior based on the traffic analysis. The traffic auditor (130) analyzes traffic in the communications network (100) to identify a deviation from the expected traffic behavior model.

### CROSS REFERENCE TO RELATED APPLICATIONS

The instant application claims priority from provisional application number 60/355,573 (Attorney Docket No. 02-4010PRO1), filed Feb. 5, 2002, the disclosure of which is incorporated by reference herein in its entirety.

The present application is a continuation-in-part of U.S. application Ser. No. 10/167,620 (Attorney Docket No. 00-4056), filed Oct. 19, 2001, the disclosure of which is incorporated by reference herein in its entirety.

### RELATED APPLICATIONS

The instant application is related to co-pending application Ser. No. 10/044,073 (Attorney Docket No. 01-4001), entitled “Systems and Methods for Point of Ingress Traceback of a Network Attack” and filed Jan. 11, 2002.

### FIELD OF THE INVENTION

The present invention relates generally to communications networks and, more particularly, to systems and methods for identifying anomalies in data streams in communications networks.

### BACKGROUND OF THE INVENTION

With the advent of the large scale interconnection of computers and networks, information security has become critical for many organizations. Active attacks on the security of a computer or network have been developed by “hackers” to obtain sensitive or confidential information. Active attacks involve some modification of the data stream, or the creation of a false data stream. Active attacks can be generally divided into four types: masquerade, replay, modification of messages, and denial of service attacks. A masquerade attack occurs when a “hacker” impersonates a different entity to obtain information which the “hacker” otherwise would not have the privilege to access. A replay attack involves the capture of data and its subsequent retransmission to produce an unauthorized effect. A modification of messages attack involves the unauthorized alteration, delay, or re-ordering of a legitimate message. A denial of service attack prevents or inhibits the normal use or management of communications facilities, such as disruption of an entire network by overloading it with messages so as to degrade its performance. These four categories of active attacks can be difficult to identify and, thus, to prevent.

Additionally, beyond conventional “hacking” attacks, unauthorized access to network resources may be attempted by entities engaging in prohibited transactions. For example, an entity may attempt to steal money from a banking institution via an unauthorized electronic funds transfer. Detection of such an attempt can be difficult, since the bank's transactions are going to be encrypted, and the transaction source and destination may be hidden in accordance with bank security guidelines.

Therefore, there exists a need for systems and methods that can detect anomalous or suspicious flows in a network, such as, for example, flows associated with attacks on the security of a network resource, or unauthorized accesses of the network resource.

### SUMMARY OF THE INVENTION

Systems and methods consistent with the present invention address this and other needs by providing mechanisms for performing traffic analysis on network traffic to detect anomalous or suspicious traffic. Traffic analysis may include observation of the pattern, frequency, and length of data within traffic flows. The results of the traffic analysis, consistent with the present invention, may be accumulated and compared with traffic that is usually expected. With knowledge of the expected traffic, the remaining traffic can be identified and investigated as anomalous traffic that may represent an attack on, or unauthorized access to, a network resource. In other exemplary embodiments, the accumulated traffic analysis data may be used to develop a temporal model of expected traffic behavior. The model may then be used to analyze network traffic to determine whether there are any deviations from the expected traffic behavior. Any deviations from the expected traffic behavior, which may represent an attack on, or unauthorized access to, a network resource, may be investigated. Investigation of the identified anomalous or suspicious traffic may include tracing particular traffic flows to their point of origin within the network. Consistent with the present invention, anomalous traffic flows may, thus, be identified and, subsequently, traced back to their points of origin within the network.

In accordance with the purpose of the invention as embodied and broadly described herein, a method of identifying anomalous traffic in a communications network includes performing traffic analysis on network traffic to produce traffic analysis data. The method further includes removing data associated with expected traffic from the traffic analysis data. The method also includes identifying remaining traffic analysis data as anomalous traffic.

In another implementation consistent with the present invention, a method of analyzing traffic in a communications network includes performing traffic analysis on traffic in the communications network. The method further includes developing a model of expected traffic behavior based on the traffic analysis. The method also includes analyzing traffic in the communications network to identify a deviation from the expected traffic behavior model.

In a further implementation consistent with the present invention, a method of tracing suspicious traffic flows back to a point of origin in a network includes performing traffic analysis on one or more flows of network traffic. The method further includes identifying at least one of the one or more flows as a suspicious flow based on the traffic analysis. The method also includes tracing the suspicious flow to a point of origin in the network.

### BRIEF DESCRIPTION OF THE DRAWINGS

The accompanying drawings, which are incorporated in and constitute a part of this specification, illustrate exemplary embodiments of the invention and, together with the description, explain the invention. In the drawings,

FIG. 1 illustrates an exemplary network in which systems and methods, consistent with the present invention, may be implemented;

FIG. 2 illustrates further details of the exemplary network of FIG. 1 consistent with the present invention;

FIG. 3 illustrates exemplary components of a traffic auditor, traceback manager, or collection agent consistent with the present invention;

FIG. 4 illustrates exemplary components of a router that includes a data generation agent consistent with the present invention;

FIG. 5 illustrates exemplary components of a data generation agent consistent with the present invention;

FIG. 6 is a flowchart that illustrates an exemplary traffic analysis process consistent with the present invention;

FIGS. 7A-7B are flowcharts that illustrate an exemplary process for identifying anomalous streams in network traffic flows consistent with the present invention; and

FIGS. 8-15 are flowcharts that illustrate exemplary processes, consistent with the present invention, for determining a point of origin of one or more traffic flows in a network.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims.

Systems and methods consistent with the present invention provide mechanisms for detecting anomalous or suspicious network traffic flows through the use of traffic analysis techniques. Traffic analysis, consistent with the present invention, may identify and possibly classify traffic flows based on observations of the pattern, frequency, and length of data within the traffic flows. The results of the traffic analysis, consistent with the present invention, may be accumulated and compared with expected traffic to identify anomalous or suspicious traffic that may represent attacks on, or unauthorized accesses to, network resources.

### EXEMPLARY NETWORK

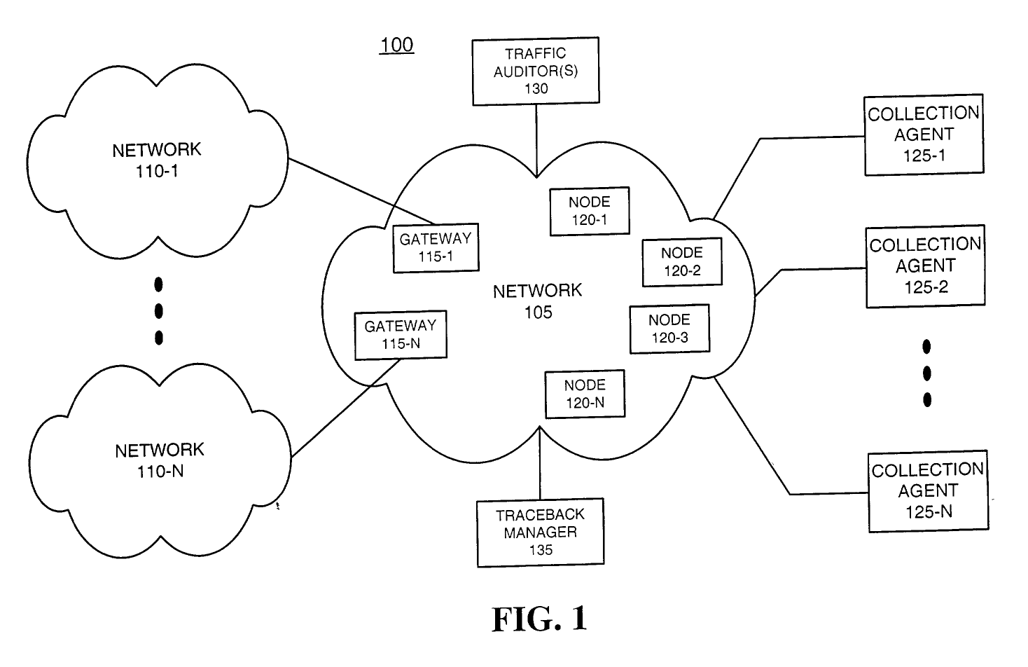

FIG. 1 illustrates an exemplary network 100 in which systems and methods, consistent with the present invention, may identify suspicious or anomalous data streams in a communications network. Network 100 may include a sub-network 105 interconnected with other sub-networks 110-1 through 110-N via respective gateways 115-1 through 115-N. Sub-networks 105 and 110-1 through 110-N may include one or more networks of any type, including a Public Land Mobile Network (PLMN), Public Switched Telephone Network (PSTN), local area network (LAN), metropolitan area network (MAN), wide area network (WAN), Internet, or Intranet. The one or more PLMN networks may include packet-switched sub-networks, such as, for example, General Packet Radio Service (GPRS), Cellular Digital Packet Data (CDPD), and Mobile IP sub-networks. Gateways 115-1 through 115-N route data from sub-network 110-1 through sub-network 110-N, respectively.

Sub-network 105 may include a plurality of nodes 120-1 through 120-N that may include any type of network node, such as routers, bridges, hosts, servers, or the like. Network 100 may further include one or more collection agents 125-1 through 125-N, a traffic auditor(s) 130, and a traceback manager 135. Collection agents 125 may collect packet signatures of traffic sent between any node 120 and/or gateway 115 of sub-network 105. Collection agents 125 and traffic auditor(s) 130 may connect with sub-network 105 via wired, wireless or optical connection links. Traffic auditor(s) 130 may audit traffic at one or more locations in sub-network 105 using, for example, traffic analysis techniques, to identify suspicious or anomalous traffic flows. Traffic auditor(s) 130 may include a single device, or may include multiple devices located at distributed locations in sub-network 105. Traffic auditor(s) 130 may also be collocated with any gateway 115 or node 120 of sub-network 105. In such a case, traffic auditor(s) 130 may include a stand alone unit interconnected with a respective gateway 115 or node 120, or may be functionally implemented with a respective gateway 115 or node 120 as hardware and/or software. Traceback manager 135 may manage the tracing of suspicious or anomalous traffic flows to a point of origin in sub-network 105.

Though N sub-networks 110, gateways 115, nodes 120, and collection agents 125 have been described above, a one-to-one correspondence between each gateway 115, node 120, and collection agent 125 may not necessarily exist. A gateway 115 can serve multiple networks 110, and the number of collection agents may not be related to the number of sub-networks 110 or gateways 115. Additionally, there may be any number of nodes 120 in sub-network 105.

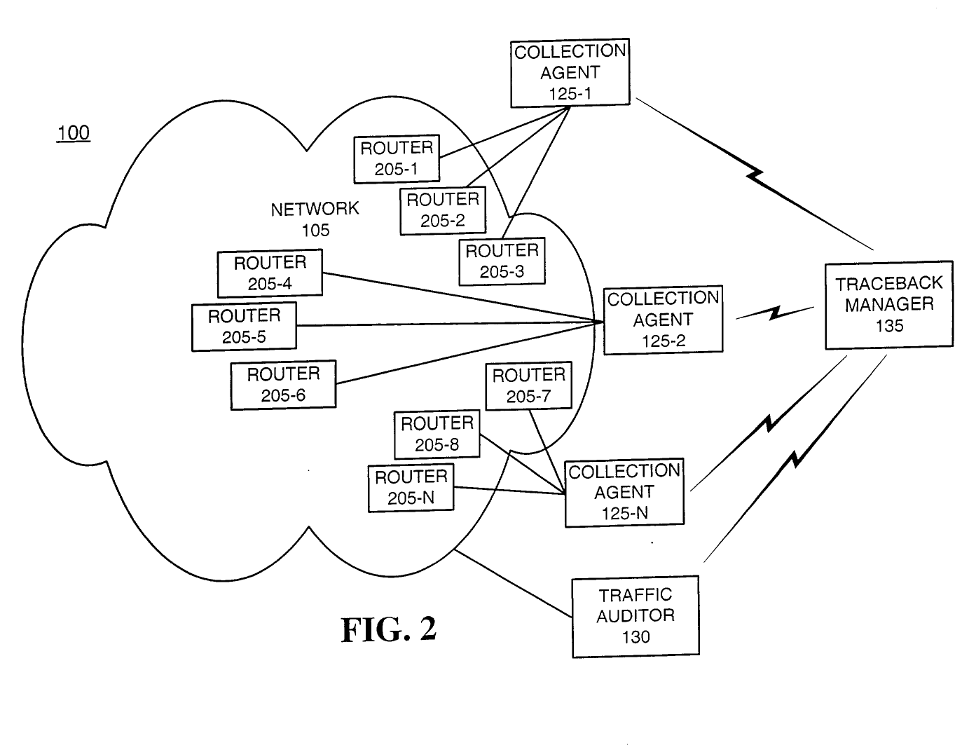

FIG. 2 illustrates further exemplary details of network 100. As shown, sub-network 105 may include one or more routers 205-1-205-N that route packets throughout at least a portion of sub-network 105. Each router 205-1-205-N may interconnect with a collection agent 125 and may include mechanisms for computing signatures of packets received at each respective router. Collection agents 125 may each interconnect with more than one router 205 and may periodically, or upon demand, collect signatures of packets received at each connected router. Collection agents 125-1-125-N and traffic auditor(s) 130 may each interconnect with traceback manager 135. Traceback manager 135 is shown using an RF connection to communicate with collection agents 125-1-125-N in FIG. 2; however, the communication means is not limited to RF, as wired or optical communication links (not shown) may also be employed.

Traffic auditor(s) 130 may include functionality for analyzing traffic between one or more nodes 120 of sub-network 105 using, for example, traffic analysis techniques. Based on the traffic analysis, traffic auditor(s) 130 may identify suspicious or anomalous flows between one or more nodes 120 (or gateways 115) and may report the suspicious or anomalous flows to traceback manager 135. Traceback manager 135 may include mechanisms for requesting the signatures of packets associated with the suspicious or anomalous flows received at each router connected to a collection agent 115-1-115-N.

### EXEMPLARY TRAFFIC AUDITOR

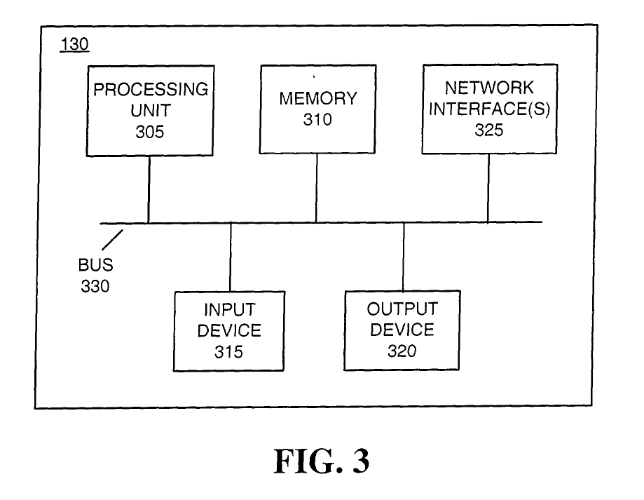

FIG. 3 illustrates exemplary components of traffic auditor 130 consistent with the present invention. Traceback manager 135 and collection agents 125-1 through 125-N may also be similarly configured event though they are not illustrated in FIG. 3. Traffic auditor 130 may include a processing unit 305, a memory 310, an input device 315, an output device 320, network interface(s) 325 and a bus 330.

Processing unit 305 may perform all data processing functions for inputting, outputting, and processing of data. Memory 310 may include Random Access Memory (RAM) that provides temporary working storage of data and instructions for use by processing unit 305 in performing processing functions. Memory 310 may additionally include Read Only Memory (ROM) that provides permanent or semi-permanent storage of data and instructions for use by processing unit 305. Memory 310 can also include large-capacity storage devices, such as a magnetic and/or optical recording medium and its corresponding drive.

Input device 315 permits entry of data into traffic auditor 130 and may include a user interface (not shown). Output device 320 permits the output of data in video, audio, or hard copy format, each of which may be in human or machine-readable form. Network interface(s) 325 may interconnect traffic auditor 130 with sub-network 105 at one or more locations. Bus 330 interconnects the various components of traffic auditor 130 to permit the components to communicate with one another.

### EXEMPLARY ROUTER CONFIGURATION

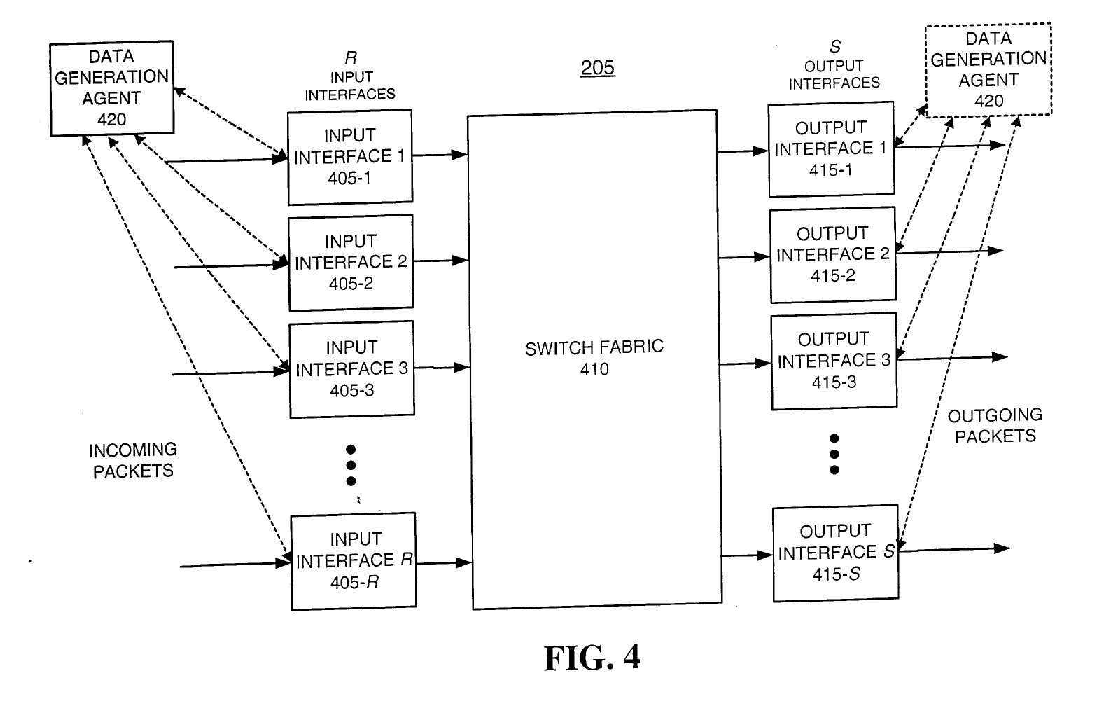

FIG. 4 illustrates exemplary components of a router 205 consistent with the present invention. In general, router 205 receives incoming packets, determines the next destination (the next “hop” in sub-network 105) for the packets, and outputs the packets as outbound packets on links that lead to the next destination. In this manner, packets “hop” from router to router in network sub-105 until reaching their final destination.

As illustrated, router 205 may include multiple input interfaces 405-1 through 405-R, a switch fabric 410, multiple output interfaces 415-1-415-S, and a data generation agent 420. Each input interface 405 of router 205 may further include routing tables and forwarding tables (not shown). Through the routing tables, each input interface 405 may consolidate routing information learned from the routing protocols of the network. From this routing information, the routing protocol process may determine the active route to network destinations, and install these routes in the forwarding tables. Each input interface may consult a respective forwarding table when determining a next destination for incoming packets.

In response to consulting a respective forwarding table, each input interface 405 may either set up switch fabric 410 to deliver a packet to its appropriate output interface 415, or attach information to the packet (e.g., output interface number) to allow switch fabric 410 to deliver the packet to the appropriate output interface 415. Each output interface 415 may queue packets received from switch fabric 410 and transmit the packets on to a “next hop.”

Data generation agent 420 may include mechanisms for computing one or more signatures of each packet received at an input interface 405, or output interface 415, and storing each computed signature in a memory (not shown). Data generation agent 420 may use any technique for computing the signatures of each incoming packet. Such techniques may include hashing algorithms (e.g., MD5 message digest algorithm, secure hash algorithm (SHS), RIPEMD-160), message authentication codes (MACs), or Cyclical Redundancy Checking (CRC) algorithms, such as CRC-32.

Data generation agent 420 may be internal or external to router 205. The internal data generation agent 420 may be implemented as an interface card plug-in to a conventional switching background bus (not shown). The external data generation agent 420 may be implemented as a separate auxiliary device connected to the router through an auxiliary interface. The external data generation agent 420 may, thus, act as a passive tap on the router's input or output links.

### EXEMPLARY DATA GENERATION AGENT

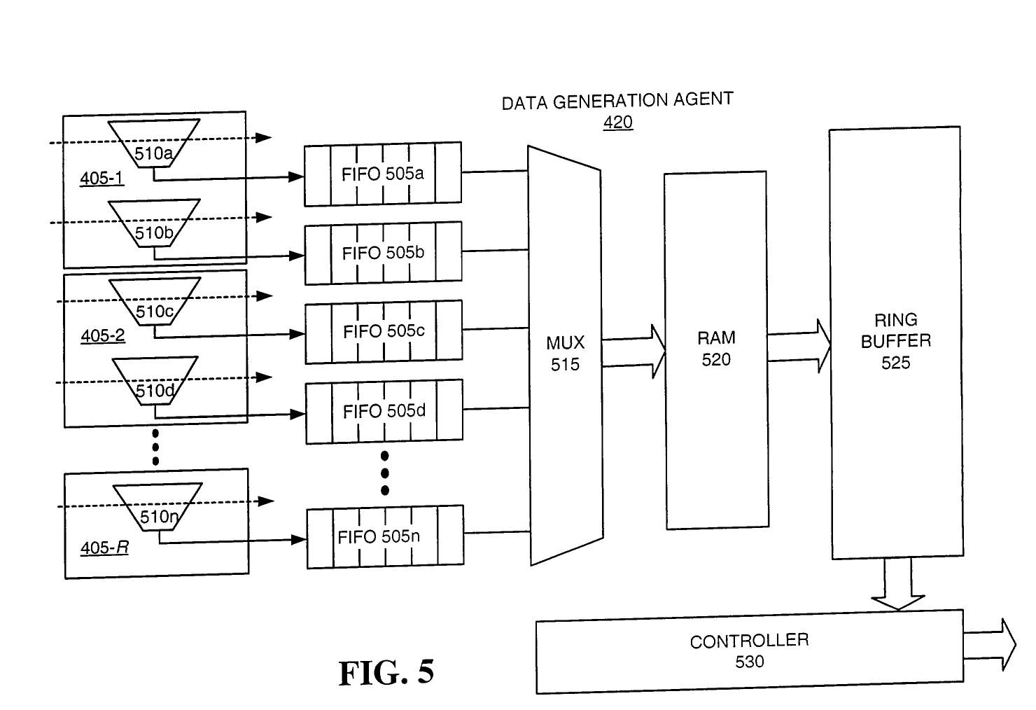

FIG. 5 illustrates exemplary components of data generation agent 420 consistent with the present invention. Data generation agent 420 may include signature taps 510a -510n, first-in-first-out (FIFO) queues 505a-505n, a multiplexer (MUX) 515, a random access memory (RAM) 520, a ring buffer 525, and a controller 530.

Each signature tap 510a-510n may produce one or more signatures of each packet received by a respective input interface 405-1-405-R (or, alternatively, a respective output interface 415-1-415-S). Such signatures typically comprise k bits, where each packet may include a variable number of p bits and k<p. FIFO queues 505a-505n may store packet signatures received from signature taps 510a-510n. MUX 515 may selectively retrieve packet signatures from FIFO queues 505a-505n and use the retrieved packet signatures as addresses for setting bits in RAM 520 corresponding to a signature vector. Each bit in RAM 520 corresponding to an address specified by a retrieved packet signature may be set to a value of 1, thus, compressing the packet signature to a single bit in the signature vector.

RAM 520 collects packet signatures and may output, according to instructions from controller 530, a signature vector corresponding to packet signatures collected during a collection interval R. RAM 520 may be implemented in the present invention to support the scaling of data generation agent 420 to very high speeds. For example, in a high-speed router, the packet arrival rate may exceed 640 Mpkts/s, thus, requiring about 1.28 Gbits of memory to be allocated to signature storage per second. Use of RAM 520 as a signature aggregation stage, therefore, permits scaling of data generation agent 420 to such higher speeds.

Ring buffer 525 may store the aggregated signature vectors from RAM 520 that were received during the last P seconds. During storage, ring buffer 525 may index each signature vector by collection interval R. Controller 530 may include logic for sending control commands to components of data generation agent 420 and for retrieving signature vector(s) from ring buffer 525 and forwarding the retrieved signature vectors to a collection agent 125.

Though the addresses in RAM 520 indicated by packet signatures retrieved from FIFO queues 505a-505n may be random (requiring a very high random access speed in RAM 520), the transfer of packet signatures from RAM 520 to ring buffer 525 can be achieved with a long burst of linearly increasing addresses. Ring buffer 525, therefore, can be slower in access time than RAM 520 as long as it has significant throughput capacity. RAM 520 may, thus, include a small high random access speed device (e.g., a SRAM) that may aggregate the random access addresses (i.e., packet signatures) coming from the signature taps 510 in such a way as to eliminate the need for supporting highly-random access addressing in ring buffer 525. The majority of the signature storage may, therefore, be achieved at ring buffer 525 using cost-effective bulk memory that includes high throughput capability, but has limited random access speed (e.g., DRAM).

### EXEMPLARY TRAFFIC ANALYSIS

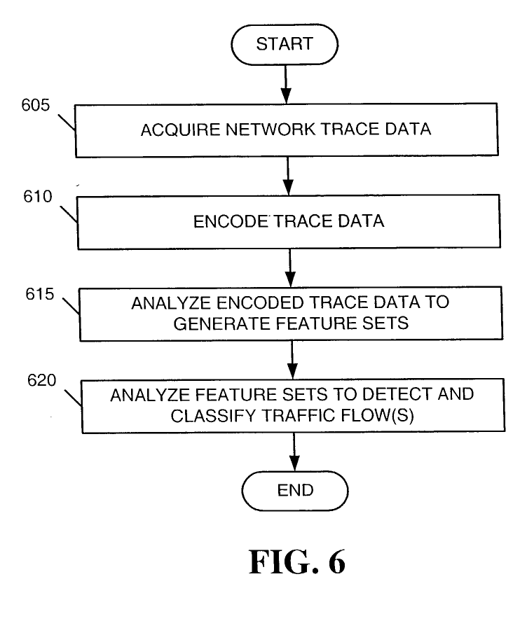

FIG. 6 is a flowchart that illustrates an exemplary process, consistent with the present invention, for performing analysis of one or more traffic streams by traffic auditor(s) 130. The exemplary process of FIG. 6 may be stored as a sequence of instructions in memory 310 of traffic auditor 130 and implemented by processing unit 305.

The exemplary traffic analysis process may begin with the acquisition of network trace data by traffic auditor(s) 130 [act 605]. Trace data may include a sequence of events associated with traffic flow(s) that are detected by traffic auditor(s) 130. Each event may include an identifiable unit of communication (i.e., a packet, cell, datagram, wireless RF burst, etc.) and may have an associated n-tuple of data, which may include a time of arrival (TOA) of when the event was detected and logged. Each event may further include a unique identifier identifying a sender of the unit of communication, a duration of the received unit of communication, a geo-location associated with the sender of the unit of communication, information characterizing the type of transmission (e.g., radio, data network, etc.), and a signal strength associated with the transmitted unit of communication.

Subsequent to acquisition, the acquired network trace data may be encoded [act 610]. Any number of trace data encoding schemes may be used, including, for example, the event time of arrival (TOA) encoding, parameter value encoding, or image encoding techniques further described below. The encoded trace data may then be analyzed to generate feature sets [act 615]. One or more analysis techniques may be used for generating the feature sets, including, for example, the discrete time Fourier transform (DFT), one dimensional spectral density, Lomb periodogram, one dimensional cepstrum and cepstrogram, cross spectral density, coherence, and cross-spectrum techniques described below. The generated feature sets may further be analyzed for detecting and, possibly, classifying traffic flows [act 620]. One or more feature analysis techniques, such as those described below, may be used for detecting and classifying traffic flows.

### EXEMPLARY TRACE DATA ENCODING

Exemplary Event Time of Arrival Encoding

Acquired network trace data may be encoded into a group of time series (hereinafter described as signals) or multi-dimensional images consistent with the present invention. Such encodings may include event time of arrival (TOA) encoding, parameter value encoding, or image encoding.

Event TOA encoding may include non-uniform, uniform impulse, and uniform impulse time sampling. Non-uniform sampling may simply include a sequence of values xₙ with TOAs tₙ=0 . . . N, where t is quantized to a desired resolution. A uniform sampling requires the definition of a sample time quantization period T, where T may be set to a value such that T>1/(2ƒ_{N}) and where ƒ_{N} is the highest frequency content of the signal. Given this definition of a sampled signal, the values xₙ may be quantized into a time sequence of either impulses (δ(n)=1 for n=0) or pulses. An impulse encoding may result in a series of weighted impulses \tilde{x}(k) occurring at time samples kₙ=┌tₙ┐/T, n=0 . . . N, where the notation ┌ ┐ denotes quantization to a closest time value kT (k equal to any integer):

$$\tilde{x} ( k ) = {\sum }_{n = 0}^{N} f ( {x}_{n} ) δ ( k - {k}_{n} ) \qquad Eqn . ( 1 )$$

where ƒ(x) comprises any one of the encoding functions further described below. The notation ┌ ┐ may alternatively denote a floor or ceiling function.

The signal may further be encoded as a series of weighted pulses whose pulse height and width encode two pieces of information xₙ and yₙ:

$$\tilde{x} ( k ) = {\sum }_{n = 0}^{N} f ( {x}_{n} ) p ( k - {k}_{n} , {y}_{n} ) \qquad Eqn . ( 2 )$$

where

$$p ( k , m ) = {\sum }_{n = 0}^{m} δ ( k - n ) \qquad Eqn . ( 3 )$$

Exemplary Parameter Value Encoding Functions

Additional parameters may be encoded at each event by defining an encoding functions ƒ( ). Exemplary encoding functions may include binary, sign, real weighted, absolute value weighted, complex weighted, and multi-dimensional weighted encoding functions. An exemplary binary encoding function may include the following:

ƒ(x)=0 if x<ζ, otherwise ƒ(x)=1 Eqn. (4)

where ζ is an arbitrary constant.

An exemplary sign encoding function may include the following:

ƒ(x)=sgn(x) Eqn. (5)

An exemplary real weighted encoding function may include the following:

ƒ(x)=αx, Eqn. (6)

where α is a constant for scaling the data.

An exemplary absolute value weighted function may include the following:

ƒ(x)=αabs(x) Eqn. (7)

An exemplary complex weighted function may include the following:

ƒ(x,y)=αx+jBy for constants α and β Eqn. (8)

An exemplary multi-dimensional weighted encoding function may include the following:

ƒ(x)=\overline{α}·\overline{x} Eqn. (9)

where \overline{x} is a vector formed by all the data values at a given t, and \overline{α} is a vector of weighting constants.

Exemplary Image Encodings

The acquired trace data may be used in a two-dimensional model, such as, for example, a plot of inter-arrival time vs. arrival time. The following relations can be used in such a two-dimensional model:

\tilde{x}(k)=tₖ−tₖ₋₁, the horizontal position in the image; Eqn. (10)

\tilde{y}(k)=tₖ, the vertical position in the image; and Eqn. (11)

{tilde over ({)}(k)=ƒ(xₖ), the intensity in the image. Eqn. (12)

Using a fractal texture classification approach, the images resulting from Eqns. (10)-(12) can be segmented into data streams originating from different sources. One skilled in the art will recognize that other conventional image processing algorithms may alternatively be used for analyzing the image data generated by Eqns. (10)-(12).

### EXEMPLARY ENCODED TRACE DATA ANALYSIS

Signal or image analysis techniques that may be used, consistent with the invention, for analyzing encoded trace data may include discrete time Fourier transform (DFT), one-dimensional spectral density (periodogram), Lomb periodogram, one-dimensional cepstrum and cepstrogram, cross spectral density, coherence, and cross-spectrum techniques. Other analysis techniques, such as time varying grams, model-based spectral techniques, statistical techniques, fractal and wavelet based time-frequency techniques may be used, consistent with the present invention.

Discrete Time Fourier Transform

This technique includes a single signal technique that computes a DFT or spectrum of a signal. The DFT X(ω) of a signal x(n) of length N may be computed by the following N point DFT:

$$X ( ϖ ) = {\sum }_{n = 0}^{N - 1} w ( n ) x ( n ) {ⅇ}^{- jϖ n} \qquad Eqn . ( 13 )$$

where the window function w(n) may be chosen to improve spectral resolution (e.g., Hamming, Kaiser-Bessel, Taylor). For certain values of N, faster algorithms, such as fast fourier transform (FFT), may be used.

The DFT may be used for decomposition of a signal into a set of discrete complex sinusoids. DFT may accept single streams with uniformly spaced, single values that may include complex values and images (e.g., using DFTs/FPTs on the rows and columns). The features generated by DFTs may include complex peaks in X(ω) that correspond to frequencies of times of arrival. The magnitudes of the complex peaks may be proportional to the product of how often the arrival pattern occurs, and the scaling of the data signal. The phase of the peaks show information of the relative phases between peaks. DFTs may be of limited use when random signals or noise is present. In such cases, periodograms may be alternatively be used.

One-Dimensional Spectral Density (Periodogram)

For signals with randomness associated with them, conventional DFT/FFT processing does not provide a good unbiased estimate of the signal power spectrum. Better estimates of the signal power spectrum Pₓₓ(ω) may be obtained by averaging the power of many spectra Xₙ^{(r)}(\overline{ω}), computed with K different segments of the data, each of length N:

$$\begin{matrix}{P}_{xx} ( ϖ ) = \frac{1}{K} {\sum }_{r = 0}^{K - 1} \frac{1}{N} {\vert {X}_{N}^{( r )} ( ϖ ) \vert}^{2} & Eqn . ( 14 ) \\ {X}_{N}^{( r )} ( ϖ ) = {\sum }_{n = 0}^{N - 1} w ( n ) {x}_{r} ( n ) {ⅇ}^{- jϖ n} & Eqn . ( 15 )\end{matrix}$$

where the windowed data xᵣ(n) is the r^{th} windowed segment of x(n) and w(n) is the windowing function described above with respect to DFT/FFT.

The one-dimensional spectral density technique may be used for decomposing a random signal into a set of discrete sinusoids and for estimating an average contribution (power) of each one. The one-dimensional spectral density technique may accept single streams with uniformly spaced, single values that may include complex values. The features generated by the one-dimensional spectral density technique may include the peaks in Pₓₓ(ω) that correspond to frequencies of times of arrivals. The power of the peaks may be proportional to the product of how often the arrival pattern occurs, and the scaling of the data signal. The one-dimensional spectral density technique may be suited to signals with time varying and random characteristics.

Lomb Periodogram

This exemplary encoded trace data analysis technique computes spectral power as a function of an arbitrary angular frequency ω. The Lomb techniques (e.g., Lomb, Scargle, Barning, Vanicek) estimate a power spectrum for N points of data at any arbitrary angular frequency ω according to the following relations:

$$\begin{matrix}{P}_{N} ( ϖ ) = \frac{1}{2 {σ}^{2}} \{ \frac{{[ {\sum }_{j} ( {h}_{j} - \overline{h} ) cos ϖ ( {t}_{j} - τ ) ]}^{2}}{{\sum }_{j} {cos}^{2} ϖ ( {t}_{j} - τ )} + \frac{{[ {\sum }_{j} ( {h}_{j} - \overline{h} ) sin ϖ ( {t}_{j} - τ ) ]}^{2}}{{\sum }_{j} {sin}^{2} ϖ ( {t}_{j} - τ )} \} & Eqn . ( 16 ) \\ where \overline{h} = \frac{1}{N} {\sum }_{j - 0}^{N - 1} {h}_{j} , & Eqn . ( 17 ) \\ {σ}^{2} = \frac{1}{N - 1} {\sum }_{j = 0}^{N - 1} {( {h}_{j} - \overline{h} )}^{2} , and & Eqn . ( 18 ) \\ τ = \frac{1}{2 ϖ} {tan}^{- 1} ( \frac{{\sum }_{j} sin 2 ϖ {t}_{j}}{{\sum }_{j} cos 2 ϖ {t}_{j}} ) & Eqn . ( 19 )\end{matrix}$$

The Lomb Periodogram may be used for estimating sinusoidal spectra in non-uniformly spaced data. The Lomb Periodogram technique may accept single streams with irregularly spaced, single values. The features generated by the Lomb periodogram technique may include the power spectrum P_{N}(ω) computed at several values of ω where ω is valid over the range 0>ω>1/(2Δ), and where Δ is the smallest time between samples in the data set. Algorithms exist for a confidence measure of a given spectral peak.

One-Dimensional Cepstrum and Cepstrogram

This exemplary encoded trace data analysis technique identifies periodic components in signals by looking for harmonically related peaks in the signal spectrum. This is accomplished by performing an FFT on the log-magnitude of the spectrum X(n):

C(k)=abs(FFT¹(log|X(\overline{ω})|)) Eqn. (20)

Eqn. (20) may be modified into a Cepstrogram for use with random signals by using Pₓₓ(ω) instead of X(ω). The one-dimensional Cepstrum function may be used for estimating periodic components in uniformly spaced data. The Cepstrum technique may accept single streams with uniformly spaced, single values that may include complex values. The features generated by the Cepstrum technique may include peaks in C(k) that correspond to periodic times of arrival. The power of the peaks may be proportional to the product of how frequently the inter-arrival time occurs, and the scaling of the data signal. A confidence measure of a given periodic peak may also be computed.

Cross Spectral Density

This exemplary encoded trace data analysis technique may compute the cross spectrum (e.g., the spectrum of the cross correlation) P_{xy}(ω) of two random sequences according to the following relation:

$$\begin{matrix}{P}_{xy} ( ϖ ) = \frac{1}{K} {\sum }_{r = 0}^{K - 1} {\frac{1}{{N}^{2}} [ {X}_{N}^{( r )} ( ϖ ) ] [ {Y}_{N}^{( r )} ( ϖ ) ]}^{*} & Eqn . ( 21 ) \\ \begin{matrix}where {X}_{N}^{( r )} ( ϖ ) = {\sum }_{n = 0}^{N - 1} {x}_{r} ( n ) {ⅇ}^{- jϖ n} , and \\ {Y}_{N}^{( r )} ( ϖ ) = {\sum }_{n = 0}^{N - 1} {y}_{r} ( n ) {ⅇ}^{- jϖ n}\end{matrix} & Eqn . ( 22 )\end{matrix}$$

Cross spectral density may be used for evaluating how two spectra are related. The cross spectral density technique may accept multiple streams with uniformly spaced, single values that may include complex values. The features generated by the cross spectral density technique may include peaks that indicate two signals that are varying together in a dependent manner. Two independent signals would not result in peaks.

Coherence

This exemplary encoded trace data analysis technique computes a normalized cross spectra between two random sequences according to the following relation:

$${C}_{xy} ( ϖ ) = \frac{{\vert {P}_{xy} ( ϖ ) \vert}^{2}}{{P}_{xx} ( ϖ ) {P}_{yy} ( ϖ )} \qquad Eqn . ( 23 )$$

Coherence may be used in situations where the dynamic range of the spectra is causing scaling problems, such as, for example, in automated detection processing. The coherence technique may accept multiple streams with uniformly spaced, single values that may include complex values. The features generated by the coherence technique may include peaks when two signals, that may each have a randomly varying component at the same frequency, vary together in a dependent manner. If the two signals are independent, no peaks would be present.

Cross-Spectrum

This exemplary encoded trace data analysis technique identifies common periodic components in multiple signals according to the following relation:

C(k)=abs(FFT⁻¹(log|P_{xy}(\overline{ω})|)) Eqn. (24)

The cross spectrum technique may accept multiple streams with uniformly spaced, single values that may include complex values. The features generated by the cross-spectrum technique may include peaks in C(k) that correspond to common periodic times of arrival of the multiple signals. The power of the peaks may be proportional to the product of how frequently the common inter-arrival time occurs, and the scaling of the multiple data signals.

Time Varying Grams (Any Technique vs. Time)

The above described encoded trace data analysis techniques may only be valid when the underlying random process that generated the signal(s) is wide sense stationary. These techniques, however, will still be useful when the signal statistics vary slowly enough such that they are nominally constant over an observation time which is long enough to generate good estimates. Usually, a time series is divided into windows of a constant time duration, and the estimates are computed for each window. Often the windows are overlapped by a percentage amount, and shaded (i.e., time-wise multiplication of the data stream by a smoothing function) to reduce artifacts caused by the abrupt changes at the endpoints of the window. Each window may then be processed with the output vectors stacked together as rows or columns of a matrix, forming a two dimensional function with time as one axis and the estimated parameter as the other. Two dimensional image processing and pattern recognition may then be used to detect time varying features. Application of the above techniques to the time axis of a gram additionally allows the identification of longer term features. For example, a cepstrum of time axis data allows identification of cyclical activity on the order of the window period, which may be orders of magnitude longer than the sample period.

Model-Based Spectral Techniques

Most model-based analysis techniques require a-priori knowledge of the form of signal that is being looked for. If a correct signal model can be guessed, however, superior resolution can be achieved as compared to previously described techniques. An exemplary spectral model that may be used is the auto-regressive moving average (ARMA) model. This model allows the reduction of a complete spectrum into a small number of coefficients. Later classification may, thus, be accomplished using a significantly reduced set of inputs.

Higher Order Statistics and Polyspectra

This exemplary technique allows the use of third order and higher statistics for identifying and categorizing non-gaussian processes. The first moment E[x(n)] and second moment E[x*(n)x(n+1] represent the mean and auto-correlation of a process and may be used to characterize any non-Gaussian process. Non-Gaussian processes can contain information that may be used for identification purposes. The (n−1)^{th} order Fourier transform of the n^{th} order moment, resulting in the power spectral density, bispectrum and trispectrum of a process may be used for identifying and categorizing a non-Gaussian process. For example, while two different processes may be indistinguishable by their power spectral densities, their bispectrum and trispectrum may be used to differentiate them. The higher order statistics technique may accept single streams with uniformly spaced, single values that may include complex values.

Histograms

This exemplary encoded trace data analysis technique may compute the frequency of occurrence of specific ranges of values in a random process. Any number of conventional histogram algorithms may be used for approximating the probability distribution of signal values. Histogram algorithms may accept any type (e.g., single or multiple) of data stream. The features generated histogram algorithms may include, for example, peaks that can show preferred values.

Fractal and Wavelet-Based Time-Frequency

Wavelet techniques can generate features that span several octaves of scale. Fractal based techniques can be useful for identifying and classifying self-similar processes. The Hurst Parameter analysis technique is one example of such techniques. The Hurst parameter measures the degree of self similarity in a time series. Self similar random processes have statistics that do not change under magnification or reduction of the time scale used for analysis. Small fluctuations at small scales become larger fluctuations at larger scales. Standard statistical measures such as variance do not converge, but approach infinity as the data record size approaches infinity. However, the rate at which the statistics scale are related such that for any scaling parameter c>0, the two processes x(ct) and c^{H}x(t) are statistically equivalent (i.e., have the same finite-dimensional distributions). Many conventional techniques exist for determining the Hurst Parameter H. The Hurst Parameter may be used for determining if a random stream has self similar characteristics and may accept single streams with uniformly spaced, single values that may include complex values. The value of H can be used to estimate the self similarity property of the signal. This has the potential to identify when traffic has become chaotic, allowing the remaining analysis to be tailored appropriately.

### EXEMPLARY TRAFFIC FLOW DETECTION AND CLASSIFICATION

Consistent with the present invention, a number of techniques may be used for analyzing the feature sets generated by the encoded trace data analysis described above. Such techniques may involve the detection of steady state flows and/or the detection of multi-state flows. Feature set analysis involves determining which features (e.g., peaks or shapes in a cepstral trace) are of interest, and that can then be used to detect and possibly classify a given data stream.

When detecting steady state flows, no a-priori information about the probability of there being a shape to detect may be known. Probability theory, therefore, dictates use of the Neyman-Pearson Lemma which states that the optimum detector consists of comparing the value of a generated feature to a simple threshold y. Using such a simple threshold, two types of errors may occur: a Type 1 error in which a detection is claimed and it is not really there (a false alarm); and a Type 2 error in which there is a failure to detect an event (a miss). The probability of false alarms Pr_{FA} cannot be reduced without increasing the probability of a miss, Pr_{M}. Adjusting the threshold γ permits a selection of a balance between the two errors. Usually, the probability of detection is used (Pr_{D}=1−Pr_{M}) and a fixed false alarm rate can be chosen (fixed Pr_{FA}) and the probability of detection can be maximized. The plot of Pr_{D} vs. Pr_{FA} as a function of the threshold γ is called a Receiver Operating Characteristic (ROC curve) and can be used for tuning detection performance.

A two-dimensional Cepstrogram bin, for example, may be used for the detection process. A basic detector can compare the value in each bin to a fixed threshold value, calling a shape present if those thresholds are exceeded. An empirical approach can be taken for generating the thresholds for detecting a given periodicity shape (i.e., the detection threshold for a given bin). Assume we have K sets of “no shape present” signals (i.e., just background traffic) and L sets of “shape present” signals. A 2-D Cepstrogram may be used to generate the bin in question T( ). T(k) may be computed for each “shape not present” trace (k=1 . . . K). T(l) may be computed for each “shape present” trace (l=1 . . . L). The number n_{71 α}(γ) of incorrectly detected “no shape present” events or false alarms can be computed according to the following relation:

$${n}_{fa} ( γ ) = {\sum }_{k = 1}^{K} T ( k ) > γ \qquad Eqn . ( 25 )$$

The number n_{d}(γ) of correctly detected “shape present” events can also be computed according to the following relation:

$${n}_{d} ( γ ) = {\sum }_{l = 1}^{L} T ( l ) > γ \qquad Eqn . ( 26 )$$

If values of K and L are chosen large enough, good estimates of Pr_{FA} and Pr_{D} as a function of γ can be achieved:

$$\begin{matrix}{Pr}_{FA} ( γ ) ≅ \frac{{n}_{fa} ( γ )}{K + L} & Eqn . ( 27 ) \\ {Pr}_{D} ( γ ) ≅ \frac{{n}_{d} ( γ )}{K + L} & Eqn . ( 28 )\end{matrix}$$

With the above computed information, an ROC curve can be generated and various measures may be used to select the operating point. An exemplary operating point would involve fixing the Pr_{Fa} to an acceptable value, thus, determining the resulting γ and Pr_{D}.

Flows that have very steady state characteristics can be classified with a simple threshold based classifier. Flows that have identifiable states, such as those caused by congestion windows in TCP/IP, may be detected using a Hidden Markov Model (HMM) technique. An HMM representation incorporates the temporal aspect of the event data as well as the higher order characteristics (e.g., packet size) of each event. An HMM can be considered a finite state machine, where transitions can occur between any two states, but in a probabilistic manner. Each state has a measurable output that can be either deterministic or probabilistic. Consistent with the present invention, the outputs may be the features of events in a network trace. In the context of detecting (or differentiating between) shapes, a given HMM can be trained on the “flow shape” data set using a standard technique, such as, for example, Baum-Welch re-estimation. The trained HMM may then be used to “score” unknown data sets using another conventional technique, such as, for example, a “forward-backward” procedure. The resulting “score” may be compared to the threshold γ.

Detection of traffic flows can be extended to the classification of traffic flows. In classification, the goal is to determine the types of communications taking place (e.g., multi-cast, point to point, voice, data). Given an n-dimensional distribution of events (many events, each with n features), a classifier attempts to partition the space into discrete areas that group the events into several categories. The previously described threshold detector simply partitions the space into two half spaces separated by a straight line. A classifier using the threshold approach previously described may be constructed by using a bank of detectors trained for different data. Data containing an unknown class of flow may be applied to the bank of detectors, and the one that generates the highest “score” indicates the class of the unknown pattern. To classify using HMMs, several HMMs may be trained on a specific class of pattern. The unknown data flow can be applied to the HMMs using, for example, the “forward-backward” procedure, and again, the one that generates the highest “score” indicates the class of the unknown pattern.

### EXEMPLARY ANOMALOUS DATA STREAM IDENTIFICATION PROCESS

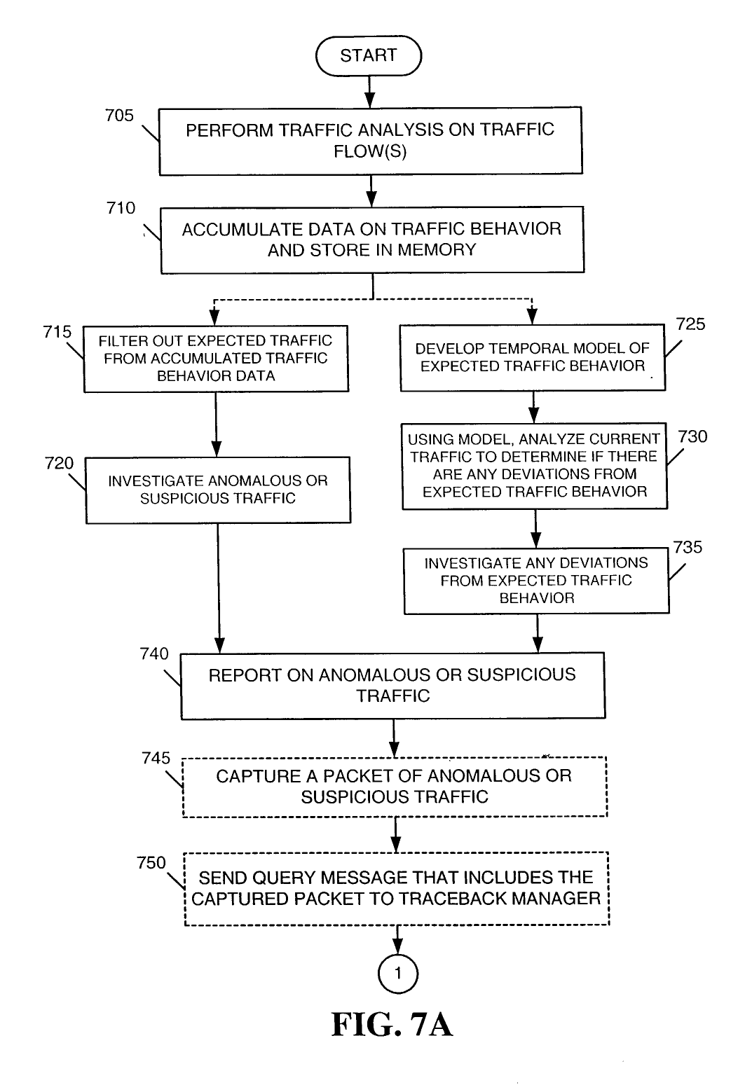

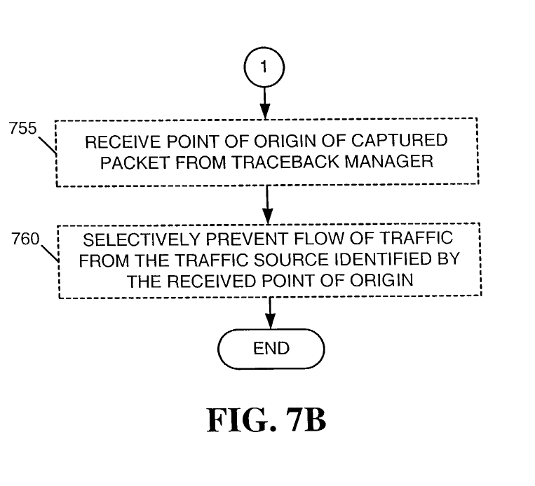

FIGS. 7A-7B are flowcharts that illustrate an exemplary process, consistent with the present invention, for identifying anomalous or suspicious data streams in network traffic flows. The exemplary process of FIG. 7 may be stored as a sequence of instructions in memory 310 of traffic auditor 130 and implemented by processing unit 305.

The process may begin with the performance of traffic analysis on one or more traffic flows by traffic auditor(s) 130 [act 705]. Traffic auditor(s) 130 may “tap” into one or more nodes and/or locations in sub-network 105 to passively sample the packets of the one or more traffic flows. Traffic analysis on the flows may be performed using the exemplary process described with respect to FIG. 6 above. Other types of traffic analysis may alternatively be used in the exemplary process of FIG. 7. Over a period of time, traffic behavior data resulting from the traffic analysis may be accumulated and stored in memory [act 710]. For example, flow identifications and classifications achieved using the exemplary process of FIG. 6 may be time-stamped and stored in memory for later retrieval.

In one exemplary embodiment, expected traffic may be filtered out of the accumulated traffic behavior data [act 715]. For example, certain identified or classified traffic flows may be expected at a location monitored by traffic auditor(s) 130. Such flows may be removed from the accumulated traffic behavior data. Traffic of the remaining traffic behavior data may then be investigated as anomalous or suspicious traffic [act 720]. Such anomalous or suspicious traffic may, for example, include attacks upon a network node 120.

In another exemplary embodiment, the accumulated traffic behavior data may be used to develop a temporal model of expected traffic behavior [act 725]. The temporal model may be developed using the time-stamped flow identifications and classifications achieved with the exemplary process of FIG. 6. Using the developed model, one or more flows of current network traffic may be analyzed to determine if there are any deviations from the expected traffic behavior [act 730]. Such deviations may include, for example, any type of attack upon a network node 120, such as, for example, a denial of service attack. Any deviations from the expected traffic behavior may be investigated as anomalous or suspicious traffic [act 735].

Subsequent to the exemplary embodiments represented by acts 715-720 and/or acts 725-735, any identified anomalous or suspicious traffic may be reported [act 740]. The anomalous or suspicious traffic may be reported to entities owning or administering any nodes 120 of sub-network 105 through which the traffic passed, including any intended destination nodes of the anomalous or suspicious traffic. Optionally, traffic auditor 130 may capture a packet of the identified anomalous or suspicious traffic [act 745]. Traffic auditor 130 may, optionally, send a query message that includes the captured packet to traceback manager 135 [act 750].

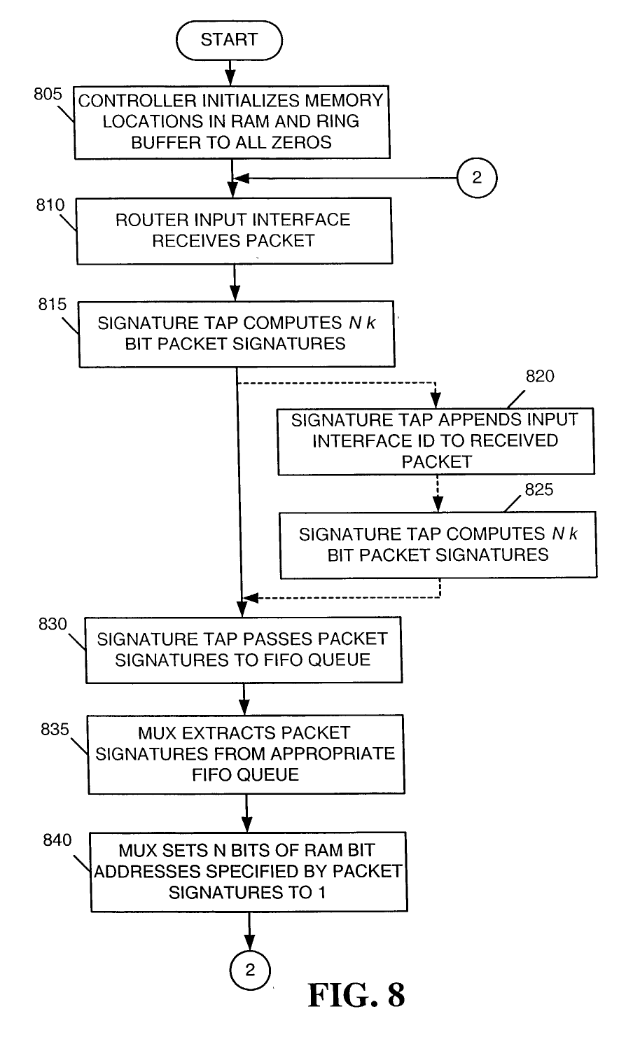

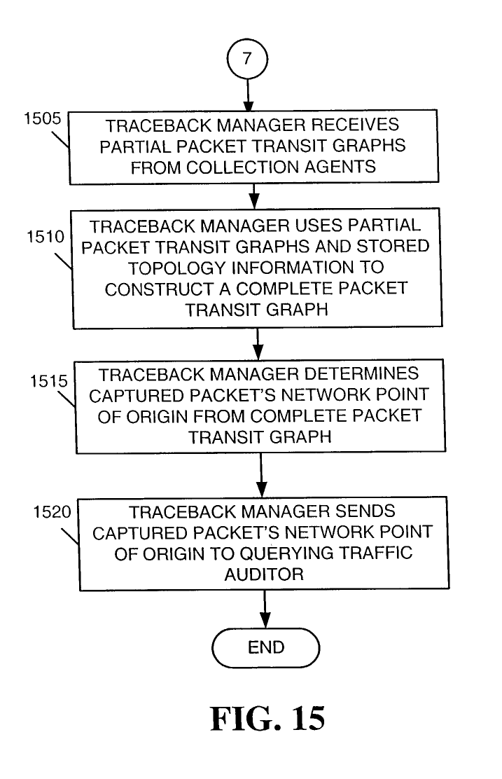

Now referring to FIG. 7B, in response to the query message, traffic auditor 130 may receive a message from traceback manager 135 that includes an identification of a point of origin of the flow associated with the captured packet in sub-network 105 [act 755]. The point of origin may be determined by traceback manager 135 in accordance with the exemplary processes described with respect to FIGS. 8-15 below. If traffic auditor 130 is associated with an Internet Service Provider (ISP), for example, traffic auditor may then, optionally, selectively prevent the flow of traffic from the traffic source identified by the network point of origin received from traceback manager 135 [act 760]. The selective prevention of the traffic flow may be based on whether a sending party associated with the traffic source identified by the network point of origin received from traceback manager 135 makes a payment to the ISP, or agrees to other contractual terms.

### EXEMPLARY DATA GENERATION AGENT PACKET SIGNATURE PROCESS

FIG. 8 is a flowchart that illustrates an exemplary process, consistent with the present invention, for computation and initial storage of packet signatures at data generation agent 520 of router 205. The process may begin with controller 530 initializing bit memory locations in RAM 520 and ring buffer 525 to a predetermined value, such as all zeros [act 805]. Router 205 may then receive a packet at an input interface 405 or output interface 415 [act 810]. Signature tap 510 may compute k bit packet signatures for the received packet [act 815]. Signature tap 510 may compute the packet signatures using, for example, hashing algorithms, message authentication codes (MACs), or Cyclical Redundancy Checking (CRC) algorithms, such as CRC-32. Signature tap 510 may compute N k-bit packet signatures, with each packet signature possibly being computed with a different hashing algorithm, MAC, or CRC algorithm. Alternatively, signature tap 510 may compute a single packet signature that includes N*k bits, with each k-bit subfield of the packet signature being used as an individual packet signature. Signature tap 510 may compute each of the packet signatures over the packet header and the first several (e.g., 8) bytes of the packet payload, instead of computing the signature over the entire packet. At optional acts 820 and 825, signature tap 510 may append an input interface identifier to the received packet and compute N k-bit packet signatures.

Signature tap 510 may pass each of the computed packet signatures to a FIFO queue 505 [act 830]. MUX 515 may then extract the queued packet signatures from an appropriate FIFO queue 505 [act 835]. MUX 515 may further set bits of the RAM 520 bit addresses specified by each of the extracted packet signatures to 1 [act 840]. Each of the N k-bit packet signatures may, thus, correspond to a bit address in RAM 520 that is set to 1. The N k-bit packet signatures may, therefore, be represented by N bits in RAM 520.

### EXEMPLARY DATA GENERATION AGENT PACKET SIGNATURE AGGREGATION PROCESS

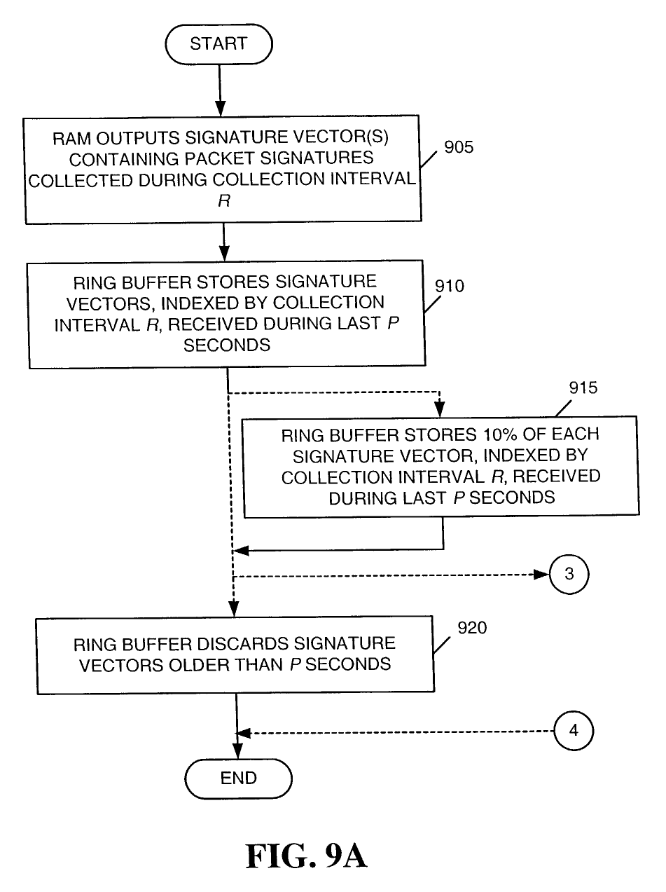

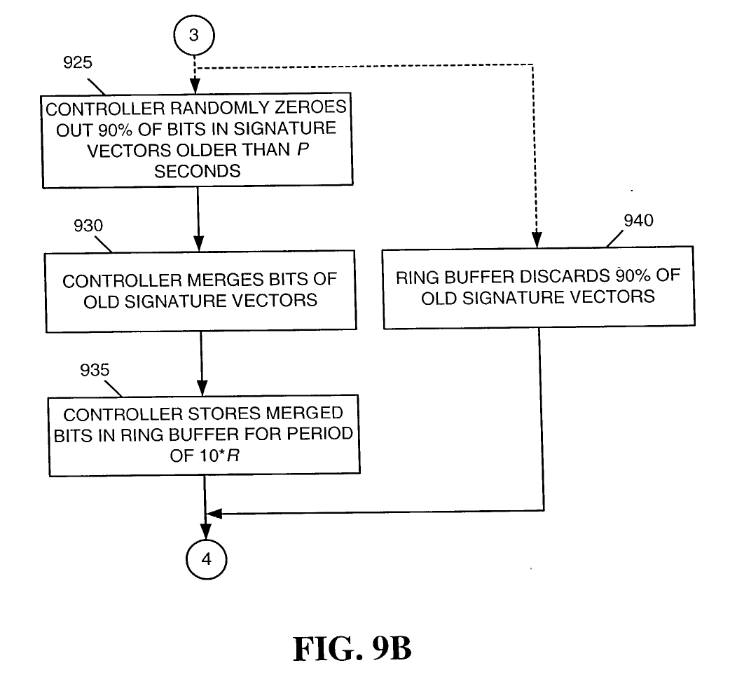

FIGS. 9A-9B are flowcharts that illustrate an exemplary process, consistent with the present invention, for storage of signature vectors in ring buffer 525 of data generation agent 420. At the end of a collection interval R, the process may begin with RAM 520 outputting a signature vector that includes multiple signature bits (e.g., 2^{k}) containing packet signatures collected during the collection interval R [act 905]. Ring buffer 525 receives signature vectors output by RAM 520 and stores the signature vectors, indexed by collection interval R, that were received during a last P seconds [act 910]. One skilled in the art will recognize that appropriate values for k, R and P May be selected based on factors, such as available memory size and speed, the size of the signature vectors, and the aggregate packet arrival rate at router 205. Optionally, at act 915, ring buffer 525 may store only some fraction of each signature vector, indexed by the collection interval R, that was received during the last P seconds. For example, ring buffer 525 may store only 10% of each received signature vector.

Ring buffer 525 may further discard stored signature vectors that are older than P seconds [act 920]. Alternatively, at optional act 925 (FIG. 9B), controller 530 may randomly zero out a fraction of bits of signature vectors stored in ring buffer 525 that are older than P seconds. For example, controller 530 may zero out 90% of the bits in stored signature vectors. Controller 530 may then merge the bits of the old signature vectors [act 930] and store the merged bits in ring buffer 525 for a period of 10*R [act 935]. Furthermore, at optional act 940, ring buffer 525 may discard some fraction of old signature vectors, but may then store the remainder. For example, ring buffer 525 may discard 90% of old signature vectors.

### EXEMPLARY DATA GENERATION AGENT SIGNATURE FORWARDING PROCESS

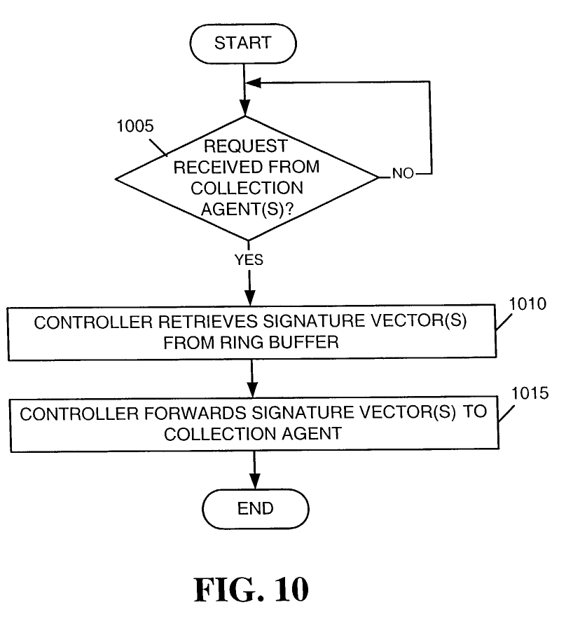

FIG. 10 is a flowchart that illustrates an exemplary process, consistent with the present invention, for forwarding signature vectors from a data generation agent 420, responsive to requests received from a data collection agent 125. The process may begin with controller 530 determining whether a signature vector request has been received from a collection agent 125-1-125-N [act 1005]. If no request has been received, the process may return to act 1005. If a request has been received from a collection agent 125, controller 530 retrieves signature vector(s) from ring buffer 525 [act 1010]. Controller 530 may, for example, retrieve multiple signature vectors that were stored around an estimated time of arrival of the captured packet (i.e., packet captured at traffic auditor(s) 130) in sub-network 105. Controller 530 may then forward the retrieved signature vector(s) to the requesting collection agent 125 [act 1015].

### EXEMPLARY PACKET SIGNATURE PROCESS

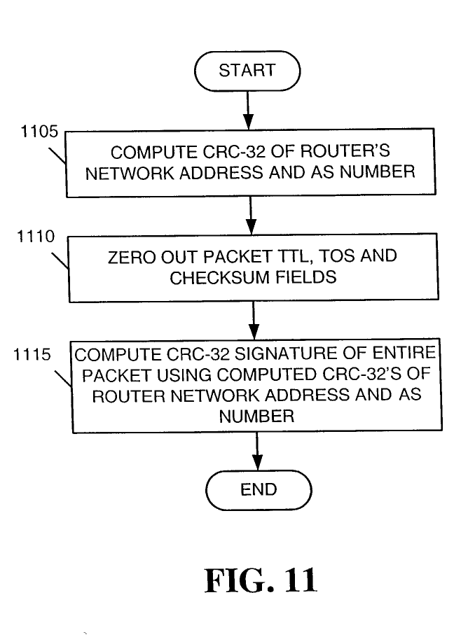

FIG. 11 illustrates an exemplary process, consistent with the present invention, for computation, by signature tap 510, of packet signatures using an exemplary CRC-32 technique. To begin the exemplary process, signature tap 510 may compute a CRC-32 of router 205's network address and Autonomous System (AS) number [act 1105]. The AS number may include a globally-unique number identifying a collection of routers operating under a single administrative entity. After receipt of a packet at input interface 405 or output interface 415, signature tap 510 may inspect the received packet and zero out the packet time-to-live (TTL), type-of-service (TOS), and packet checksum (e.g., error detection) fields [act 1110]. Signature tap 510 then may compute a CRC-32 packet signature of the entire received packet using the previously computed CRC-32's of router 205's network address and AS number [act 1115].

### EXEMPLARY NETWORK POINT OF ORIGIN TRACEBACK PROCESS

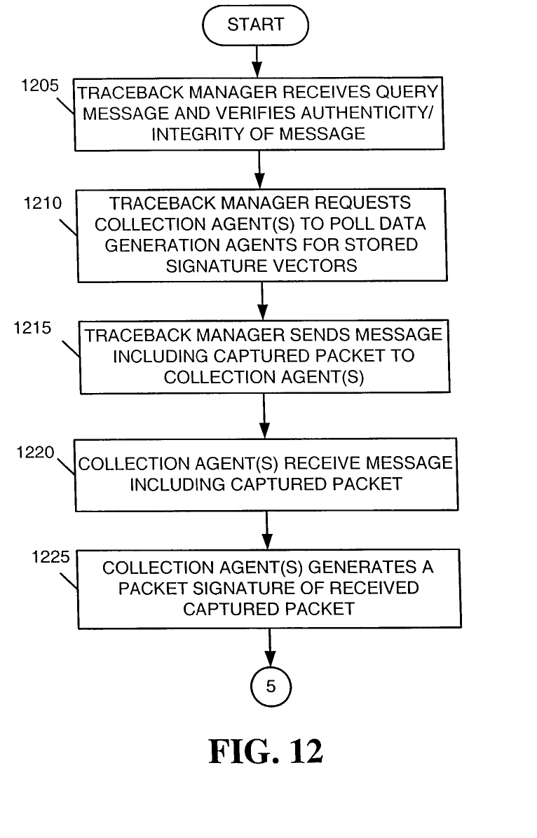

FIGS. 12-15 illustrate an exemplary process, consistent with the present invention, for tracing back a captured packet to the packet's point of origin in sub-network 105. As one skilled in the art will appreciate, the process exemplified by FIGS. 12-15 can be implemented as sequences of instructions and stored in a memory 310 of traceback manager 135 or collection agent 125 (as appropriate) for execution by a processing unit 305.

To begin the exemplary point of origin traceback process, traceback manager 135 may receive a query message from traffic auditor(s) 130, that includes a packet of an anomalous or suspicious flow captured by traffic auditor(s) 130, and may verify the authenticity and/or integrity of the message using conventional authentication and error correction algorithms [act 1205]. Traceback manager 135 may request collection agents 125-1-125-N to poll their respective data generation agents 420 for stored signature vectors [act 1210]. Traceback manager 135 may send a message including the captured packet to the collection agents 125-1-125-N [act 1215].

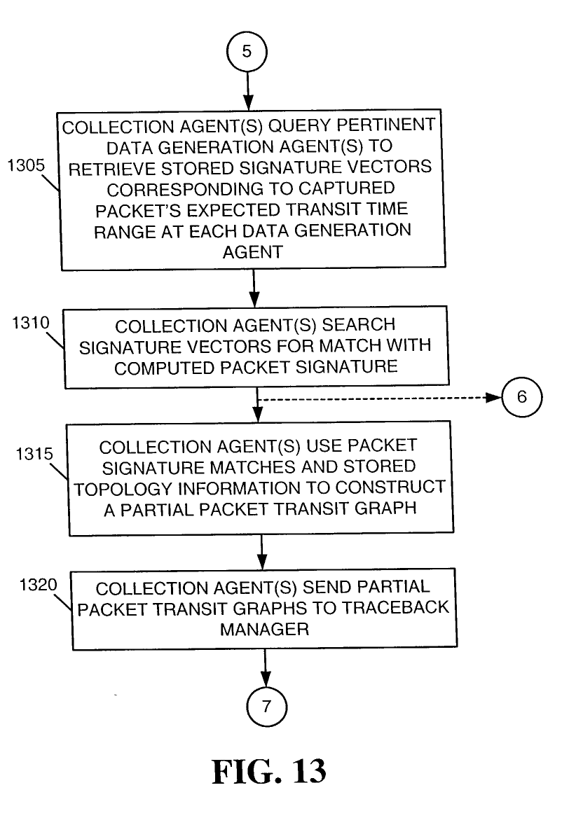

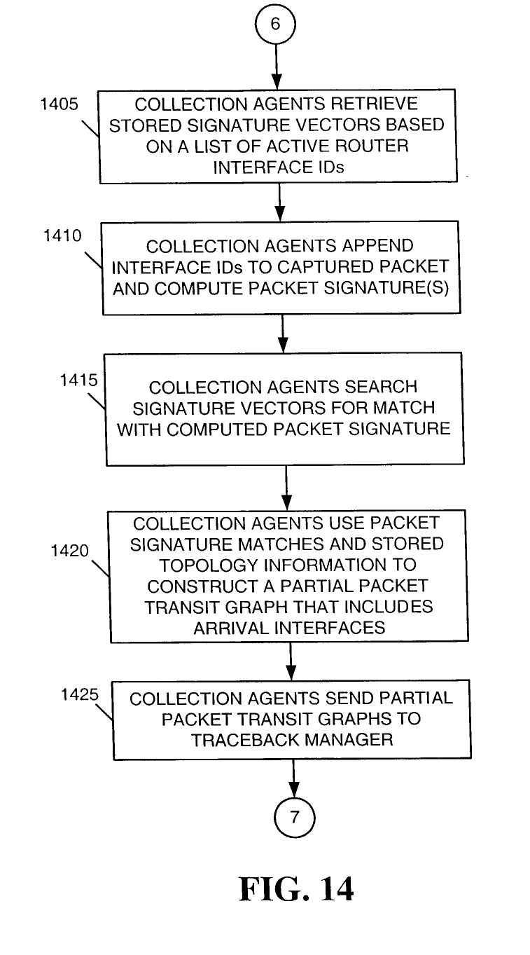

Collection agents 125-1-125-N may receive the message from traceback manager 135 that includes the captured packet [act 1220]. Collection agents 125-1-125-N may generate a packet signature of the captured packet [act 1225] using the same hashing, MAC code, or Cyclical Redundancy Checking (CRC) algorithms used in the signature taps 510 of data generation agents 420. Collection agents 125-1-125-N may then query pertinent data generation agents 420 to retrieve signature vectors, stored in respective ring buffers 525, that correspond to the captured packet's expected transmit time range at each data generation agent 420 [act 1305]. Collection agents 125-1-125-N may search the retrieved signature vectors for matches with the captured packet's signature [act 1310]. If there are any matches, the exemplary process may continue with either acts 1315-1320 of FIG. 13 or acts 1405-1425 of FIG. 14.

At act 1315, collection agents 125a-125n use the packet signature matches and stored network topology information to construct a partial packet transit graph. For example, collection agents 125-1-125-N may implement conventional graph theory algorithms for constructing a partial packet transit graph. Such graph theory algorithms, for example, may constuct a partial packet transit graph using the location where the packet was captured as a root node and moving backwards to explore each potential path where the captured packet has been. Each collection agent 125-1-125-N may store limited network topology information related only to the routers 205 to which each of the collection agents 125 is connected. Collection agents 125-1-125-N may then send their respective partial packet transit graphs to traceback manager 135 [act 1320].

At act 1405, collection agents 125-1-125-N may retrieve stored signature vectors based on a list of active router interface identifiers. Collection agents 125-1-125-N may append interface identifiers to the received captured packet and compute a packet signature(s) [act 1410]. Collection agents 125-1-125-N may search the retrieved signature vectors for matches with the computed packet signature(s) [act 1415]. Collection agents 125-1-125-N may use the packet signature matches and stored topology information to construct a partial packet transit graph that includes the input interface at each router 205 through which the intruder packet arrived [act 1420]. Collection agents 125-1-125-N may each then send the constructed partial packet transit graph to traceback manager 135 [act 1425].

Traceback manager 135 may receive the partial packet transit graphs sent from collection agents 125-1-125-N [act 1505]. Traceback manager 135 may then use the received partial packet transit graphs and stored topology information to construct a complete packet transit graph [act 1510]. The complete packet transit graph may be constructed using conventional graph theory algorithms similar to those implemented in collection agents 125-1-125-N.

Using the complete packet transit graph, traceback manager 135 may determine the point of origin of the captured packet in sub-network 105 [act 1515]. Traceback manager 135 may send a message that includes the determined captured packet network point of origin to the querying traffic auditor 130 [act 1520].

### CONCLUSION

Systems and methods consistent with the present invention, therefore, provide mechanisms that permit the identification of anomalous or suspicious network traffic through the accumulation of observations of the pattern, frequency, and length of data within traffic flows. The accumulated observations may be compared with traffic that is usually expected. With knowledge of the expected traffic, the remaining traffic can be identified by traffic analysis and investigated as anomalous traffic that may represent an attack on, or unauthorized access to, a network resource. The accumulated observations may further be used to develop a temporal model of expected traffic behavior. The model may then be used to analyze network traffic to determine whether there are any deviations from the expected traffic behavior. Any deviations from the expected traffic behavior, which may represent an attack on, or unauthorized access to, a network resource, may be investigated. Investigation of the identified anomalous or suspicious traffic may include tracing particular traffic flows to their point of origin with the network. Consistent with the present invention, anomalous traffic flows may be identified and, subsequently, traced back to their points of origin within the network.

The foregoing description of exemplary embodiments of the present invention provides illustration and description, but is not intended to be exhaustive or to limit the invention to the precise form disclosed. Modifications and variations are possible in light of the above teachings or may be acquired from practice of the invention. For example, while certain components of the invention have been described as implemented in hardware and others in software, other configurations may be possible. As another example, additional embodiments of the present invention may monitor traffic between a source and destination, perform analysis on the traffic, and issue an authorization(s) to the receiving and/or sending parties. The issued authorization(s) may confirm that the transfer, from source to destination was not intercepted or contaminated. Without the authorization(s), the destination may be inhibited from making use of selected data contained in the traffic. These additional embodiments may have application to situations where sums of money are transferred. Use of an authorization(s) may provide security to the sender in that the sender would not have to pay a debt twice (i.e., once to an eavesdropper and once to the destination). Use of an authorization(s) may additionally protect the destination, especially if information, such as a pin number, was transferred to the sender before receiving the money. The above described additional embodiments may be offered as a service to financial institutions, such as, for example, banks, brokerage houses, or the like.

While series of steps have been described with regard to FIGS. 6-15, the order of the steps is not critical. The scope of the invention is defined by the following claims and their equivalents.

What is claimed is:

1. A method of identifying anomalous traffic in a communications network, comprising:
performing traffic analysis on network traffic to produce traffic analysis data;
removing data associated with expected traffic from the traffic analysis data; and
identifying remaining traffic analysis data as anomalous traffic.

2. The method of claim 1, further comprising:
investigating the anomalous traffic.

3. The method of claim 1, further comprising:
tracing the anomalous network traffic to a point of origin in the communications network.

4. The method of claim 1, further comprising:
capturing one or more blocks of data of the anomalous traffic; and
sending the one or more blocks of data to a traceback device for tracing the anomalous network traffic to a point of origin in the communications network.

5. A device for auditing network traffic, comprising:
a memory configured to store instructions; and
a processing unit configured to execute the instructions in memory to:
conduct traffic analysis on the network traffic to produce traffic analysis data,
identify expected network traffic,
eliminate data associated with the expected traffic from the traffic analysis data, and
identify remaining traffic analysis data as anomalous traffic.

6. The device of claim 5, the processing unit further configured to:
investigate the anomalous network traffic.

7. The device of claim 5, the processing unit further configured to:
initiate tracing of the anomalous network traffic to a point of origin in the communications network.

8. The device of claim 5, the processing unit further configured to:
capture one or more blocks of data of the anomalous traffic, and send the one or more blocks of data to a traceback device for tracing the anomalous network traffic to a point of origin in the communications network.

9. A computer-readable medium containing instructions for controlling at least one processor to perform a method of identifying anomalous traffic in a communications network, the method comprising:
performing traffic analysis on network traffic to produce traffic analysis data;
identifying expected network traffic;
removing data associated with the expected traffic from the traffic analysis data; and
identifying remaining traffic analysis data as anomalous traffic.

10. The computer-readable medium of claim 9, the method further comprising:
investigating the anomalous network traffic.

11. The computer-readable medium of claim 9, the method further comprising:
tracing the anomalous network traffic to a point of origin in the communications network.

12. The computer-readable medium of claim 9, the method further comprising:
capturing one or more blocks of data of the anomalous traffic; and
sending the one or more blocks of data to a traceback device for tracing the anomalous network traffic to a point of origin in the communications network.

13. A method of analyzing traffic in a communications network, comprising:
performing traffic analysis on traffic in the communications network;
developing a model of expected traffic behavior based on the traffic analysis; and
analyzing traffic in the communications network to identify a deviation from the expected traffic behavior model.

14. The method of claim 13, further comprising:
investigating the deviation from the expected traffic behavior.

15. The method of claim 14, further comprising:
reporting on results of the investigation.

16. The method of claim 13, further comprising:
tracing traffic associated with the deviation to a point of origin in the communications network.

17. A device for analyzing traffic in a communications network, comprising:
a memory configured to store instructions; and
a processing unit configured to execute the instructions in memory to:
conduct traffic analysis on traffic in the communications network;
construct a model of expected traffic behavior based on the traffic analysis; and
analyze traffic in the communications network to identify a deviation from the expected traffic behavior model.

18. The device of claim 17, the processing unit further configured to:
investigate the deviation from the expected traffic behavior.

19. The device of claim 18, the processing unit further configured to:
report on results of the investigation.

20. The device of claim 17, the processing unit further configured to:
initiate the tracing of traffic associated with the deviation to a point of origin in the communications network.

21. A computer-readable medium containing instructions for controlling at least one processor to perform a method for analyzing traffic in a communications network, the method comprising:
conducting traffic analysis on traffic at one or more locations in the communications network; constructing a model of expected traffic behavior based on the traffic analysis; and
analyzing traffic at the one or more locations in the communications network to identify a deviation from the expected traffic behavior model.

22. The computer-readable medium of claim 21, the method further comprising:
investigating the deviation from the expected traffic behavior.

23. The computer-readable medium of claim 22, further comprising:
reporting on results of the investigation.

24. The computer-readable of claim 21, the method further comprising:
tracing traffic associated with the deviation to a point of origin in the communications network.

25. A method of tracing suspicious traffic flows back to a point of origin in a network, comprising:
performing traffic analysis on one or more flows of network traffic;
identifying at least one of the one or more flows as a suspicious flow based on the traffic analysis; and
tracing the suspicious flow to a point of origin in the network.

26. The method of claim 25, wherein tracing the suspicious flow to a point of origin comprises:
capturing at least one block of data associated with the suspicious flow; and
forwarding the captured block of data to a traceback device for tracing the suspicious flow to the point of origin in the network.

27. The method of claim 25, wherein performing traffic analysis comprises:
utilizing at least one of discrete time Fourier transform (DFT), one-dimensional spectral density (periodogram), Lomb periodogram, one-dimensional cepstrum, cross spectral density, coherence, cross-spectrum, time varying grams, model-based spectral, statistical, and fractal and wavelet based time-frequency techniques in analyzing the one or more flows of traffic.

28. The method of claim 25, further comprising:
prohibiting traffic flows from the point of origin.

29. A traffic auditing device, comprising:
a memory configured to store instructions; and
a processing unit configured to execute the instructions in memory to:
conduct traffic analysis on one or more flows of network traffic,
identify at least one of the one or more flows as a suspicious flow based on the traffic analysis, and
trace the suspicious flow to a point of origin in the network.

30. The device of claim 29, the processing unit further configured to:
capture at least one block of data associated with the suspicious flow; and
initiate the sending of the captured data block to a traceback device for tracing the suspicious flow to the point of origin in the network.

31. The device of claim 29, the processing unit further configured to:
utilize at least one of discrete time Fourier transform (DFT), one-dimensional spectral density (periodogram), Lomb periodogram, one-dimensional cepstrum, cross spectral density, coherence, cross-spectrum, time varying grams, model-based spectral, statistical, and fractal and wavelet based time-frequency techniques in conducting traffic analysis on the one or more flows of traffic.

32. The device of claim 29, the processing unit further configured to:
prohibit traffic flows from the point of origin.

33. A computer-readable medium containing instructions for controlling at least one processor to perform a method of tracing suspicious traffic flows back to a point of origin in a network, the method comprising:
conducting traffic analysis on one or more flows of network traffic;
identifying at least one of the one or more flows as a suspicious flow based on the traffic analysis; and
tracing the suspicious flow to a point of origin in the network.

34. The computer-readable medium of claim 33, wherein tracing the suspicious flow to a point of origin comprises:
capturing at least one block of data associated with the suspicious flow; and
sending the captured block of data to a traceback device for tracing the suspicious flow to the point of origin in the network.

35. The computer-readable medium of claim 33, wherein conducting traffic analysis comprises:
utilizing at least one of discrete time Fourier transform (DFT), one-dimensional spectral density (periodogram), Lomb periodogram, one-dimensional cepstrum, cross spectral density, coherence, cross-spectrum techniques, time varying grams, model-based spectral techniques, statistical techniques, and fractal and wavelet based time-frequency techniques in analyzing the one or more flows of traffic.

36. The computer-readable medium of claim 33, the method further comprising:
prohibiting traffic flows from the point of origin.

37. A system for analyzing traffic in a communications network, comprising:
means for performing traffic analysis on traffic in the communications network;
means for developing a model of expected traffic behavior based on the traffic analysis; and
means for analyzing traffic in the communications network to identify a deviation from the expected traffic behavior model.

38. A method of providing one or more authorizations to at least one of a source and destination of traffic in a communications network, comprising:
performing traffic analysis on traffic between the source and destination to determine whether the traffic between the source and destination was intercepted or contaminated; and
selectively issuing, based on results of the traffic analysis, one or more authorizations to the at least one of the source and destination, the one or more authorizations indicating that the traffic between the source and destination was not intercepted or contaminated.

39. The method of claim 38, wherein, upon receipt of the one or more authorizations, the at least one of the source and destination uses selected data contained within the traffic.

40. The method of claim 38, further comprising:
refraining from issuing, based on results of the traffic analysis, any authorizations to the at least one of the source and destination.

41. The method of claim 40, wherein, upon not receiving any authorizations, the at least one of the source and destination does not use selected data contained within the traffic.

42. The method of claim 38, wherein performing traffic analysis comprises:
utilizing at least one of discrete time Fourier transform (DFT), one-dimensional spectral density (periodogram), Lomb periodogram, one-dimensional cepstrum, cross spectral-density, coherence, cross-spectrum, time varying grams, model-based spectral, statistical, and fractal and wavelet based time-frequency techniques in analyzing the traffic between the source and destination.

43. A device for providing one or more authorizations to at least one of a source and destination of traffic in a communications network, comprising:
a memory configured to store instructions; and
a processing unit configured to execute the instructions in memory to:
perform traffic analysis on traffic between the source and destination to determine whether the traffic between the source and destination was intercepted or contaminated, and
selectively issue, based on results of the traffic analysis, one or more authorizations to the at least one of the source and destination, the one or more authorizations indicating that the traffic between the source and destination was not intercepted or contaminated.

44. A computer-readable medium containing instructions for controlling at least one processor to perform a method of providing one or more authorizations to at least one of a source and destination of traffic in a communications network, the method comprising:
performing traffic analysis on traffic between the source and destination to determine whether the traffic between the source and destination was intercepted or contaminated; and
selectively issuing, based on results of the traffic analysis, one or more authorizations to the at least one of the source and destination, the one or more authorizations indicating that the traffic between the source and destination was not intercepted or contaminated.
